(19) United States
(12) Patent Application Publication
(10) Pub. No.: US 2020/0039264 A1
(43) Pub. Date: Feb. 6, 2020

(54) SYSTEMS AND TECHNIQUES FOR RE-INKING A CONTINUOUS BAND IN A THERMAL TRANSFER PRINTER

(71) Applicant: Dover Europe Sarl, Vernier (CH)

(72) Inventors: Ann Benjamin, Spofford, NH (US); Stacey C. Goodale, Swanzey, NH (US); Frances H. Benton, Keene, NH (US); James M. Cheever, Keene, NH (US); Simon Starkey, Leicestershire (GB)

(21) Appl. No.: 16/338,927

(22) PCT Filed: Oct. 6, 2017
(86) PCT No.: PCT/IB2017/056192

§ 371 Date: Apr. 2, 2019

Related U.S. Application Data
(60) Provisional application No. 62/405,134, filed on Oct. 6, 2016.

(51) Int. Cl. B41J 31/16; B41J 2/48

(52) U.S. Cl. CPC B41J 31/16; B41J 2/48

(57) ABSTRACT

Methods, systems, and apparatus for thermal transfer printing include, in at least one aspect, a printing apparatus including: a band (105) to hold hot melt ink; rollers (110) to hold and transport the band with respect to a substrate (120); a printhead (125) to thermally transfer a portion of hot melt ink from the band to the substrate; an ink feed device (135) to add hot melt ink to the band, a heating device (140) to heat the ink on the band, and a rigid blade (155) that includes a pressure chamber (240); a pressure sensor (245) associated with the pressure chamber to monitor the meniscus of the melted hot melt ink on the band; and a controller (160) communicatively coupled with the pressure sensor (245) and the ink feed device, the controller to cause the ink feed device to add hot melt ink to the band based on data from the pressure sensor.

### BACKGROUND

This specification relates to systems and techniques for thermal transfer printing.

Thermal transfer printing involves the use of a ribbon to carry a material (e.g., ink) to the location of a printhead, where heat is then used to transfer the material from the ribbon to a substrate (e.g., paper or plastic). Many different variations of this general process have been developed over the last sixty years, and various improvements have also been made in the configurations and control systems employed for thermal transfer printers. For example, U.S. Pat. No. 9,340,052 describes a motor control system, a method of operating a motor control system, a tape drive including a motor control system, a method of operating such a tape drive, and a printing apparatus including such a tape drive, as can be used with thermal transfer printing.

In spool-to-spool printers, ink is supplied in ribbon form rolled onto cores, which are mounted or pressed onto spools (a supply spool and a take-up spool) in the printer. The movement of the spools can be precisely controlled by an electric motor for each spool. During a standard print operation, the motors are controlled to move the ribbon in front of the printhead at the same speed as the substrate where ink is removed from the ribbon. In order not to waste ribbon, each print should land on the ribbon directly adjacent to the previous print. This typically requires backing up the ribbon between each print in order to allow enough space on the ribbon to accelerate the ribbon to match the substrate speed before printing. In addition, rather than using a spool-to-spool arrangement, a thermal transfer printer that uses a continuous band to carry ink from a re-inking device to a printhead has been described in U.S. Pat. No. 8,922,611, filed Oct. 9, 2013, and entitled “Apparatus and method for thermal transfer printing”, which application is hereby incorporated by reference. In U.S. Pat. No. 8,922,611, a thermal transfer printing apparatus uses a continuous band to carry ink between a heated ink roller and a printhead.

### SUMMARY

This specification describes technologies relating to systems and techniques for thermal transfer printing.

In general, one or more aspects of the subject matter described in this specification can be embodied in one or more printing apparatus including: a band capable of holding hot melt ink thereon; rollers arranged to hold and transport the band with respect to a substrate; a printhead configured to thermally transfer a portion of hot melt ink from the band to the substrate to print on the substrate; an ink feed device configured to add hot melt ink to the band, a heating device configured to heat the hot melt ink on the band, and a rigid blade proximately located with the heating device and configured to control ink thickness of the hot melt ink on the band, wherein the rigid blade includes a pressure chamber opening at a leading edge of the rigid blade where a meniscus of melted hot melt ink forms on the band; a pressure sensor associated with the pressure chamber configured to monitor the meniscus of the melted hot melt ink on the band; and a controller communicatively coupled with the pressure sensor and the ink feed device, wherein the controller is configured to cause the ink feed device to add hot melt ink to the band based on data from the pressure sensor regarding the meniscus of the melted hot melt ink on the band.

In some implementations, the rigid blade includes an air channel to supply positive air pressure to the pressure chamber. In some implementations, the rigid blade includes an ink channel to supply ink to the band, and the ink feed device is integrated with the rigid blade to add the hot melt ink to the band via the ink channel. Further, in various implementations, the printing apparatus includes a thickness sensor associated with the band and configured to monitor a thickness of the hot melt ink on the band after the blade, wherein the controller is communicatively coupled with the thickness sensor and the rigid blade, and the controller is configured to reposition the blade, in accordance with a viscosity of the hot melt ink and a speed of the band, to control the thickness of the hot melt ink on the band after the blade.

The controller can be configured to reposition the rigid blade by rotating the rigid blade to adjust an angle of the rigid blade, to reposition the rigid blade by translating the rigid blade to adjust a pressure of the rigid blade against the band, or both. In some implementations, the printing apparatus includes a roller or platen positioned on a non-ink side of the band, opposite the rigid blade, wherein the roller or platen includes a compliant layer that flexes when the rigid blade is pressed onto the band on an ink side of the band. Further, in some implementations, the heating device includes a roller or platen positioned on a non-ink side of the band, opposite the rigid blade.

One or more aspects of the subject matter described in this specification can be embodied in one or more printing apparatus including: a band capable of holding hot melt ink thereon; rollers arranged to hold and transport the band with respect to a substrate; a printhead configured to thermally transfer a portion of hot melt ink from the band to the substrate to print on the substrate; an ink feed device configured to add hot melt ink to the band, a heating device configured to heat the hot melt ink on the band, and a blade proximately located with the heating device and configured to control ink thickness of the hot melt ink on the band; and a controller communicatively coupled with the blade, wherein the controller is configured to reposition the blade, in accordance with a viscosity of the hot melt ink and a speed of the band, to control the thickness of the hot melt ink on the band after the blade.

In some implementations, the ink feed device and the heating device are separate from the blade, the blade is a flexible blade coupled with a blade support and bent against the band, and the controller is configured to reposition the flexible blade by causing the blade support to translate the flexible blade to adjust a pressure of the flexible blade against the band. In some implementations, the blade is a rigid blade coupled with a blade support and pressed against the band, and the controller is configured to reposition the rigid blade by causing the blade support to rotate the rigid blade to adjust an angle of the rigid blade with respect to the band.

The controller can be further configured to reposition the rigid blade by causing the blade support to translate the rigid blade to adjust a pressure of the rigid blade against the band. The printing apparatus can include a roller or platen positioned on a non-ink side of the band, opposite the rigid blade, wherein the roller or platen includes a compliant layer that flexes when the rigid blade is pressed onto the band on an ink side of the band. In some implementations, the rigid blade includes a concave surface on a leading edge of the rigid blade adjacent the band. In some implementations, the rigid blade includes an ink channel to supply ink to the band, and the ink feed device is integrated with the rigid blade to add the hot melt ink to the band via the ink channel.

In various implementations, the printing apparatus includes a meniscus sensor configured to monitor a meniscus of melted hot melt ink on the band in front of a leading edge of the blade, the controller is communicatively coupled with the meniscus sensor and the ink feed device, and the controller is configured to cause the ink feed device to add hot melt ink to the band based on data from the meniscus sensor regarding the meniscus of the melted hot melt ink on the band in front of the leading edge of the rigid blade. The blade can be a rigid blade that includes a pressure chamber opening at a leading edge of the rigid blade where a meniscus of melted hot melt ink forms on the band, and the meniscus sensor can include a pressure sensor associated with the pressure chamber.

In various implementations, the printing apparatus includes a thickness sensor associated with the band and configured to monitor a thickness of the hot melt ink on the band after the blade, wherein the controller is communicatively coupled with the thickness sensor, and the controller is configured to reposition the blade based on data received from the thickness sensor. Moreover, the controller can be configured to reposition the blade to compensate for material wear of the blade, the blade support, the band, or a combination of these, over time.

One or more aspects of the subject matter described in this specification can be embodied in one or more printing apparatus including: a band capable of holding hot melt ink thereon; rollers arranged to hold and transport the band with respect to a substrate; a printhead configured to thermally transfer a portion of hot melt ink from the band to the substrate to print on the substrate; an ink feed device configured to add hot melt ink to the band, a heating device configured to heat the hot melt ink on the band, and a rigid blade proximately located with the heating device and configured to control ink thickness of the hot melt ink on the band; a meniscus sensor configured to monitor a meniscus of melted hot melt ink on the band in front of the leading edge of the rigid blade; and a controller communicatively coupled with the meniscus sensor and the ink feed device, wherein the controller is configured to cause the ink feed device to add hot melt ink to the band based on data from the meniscus sensor regarding the meniscus of the melted hot melt ink on the band in front of the leading edge of the rigid blade.

The rigid blade can be a heated blade. In some implementations, the rigid blade includes a concave surface on a leading edge of the rigid blade adjacent the band. In some implementations, the rigid blade includes: a concave surface on a leading edge of the rigid blade adjacent the band; a jutting lip before the concave surface on the leading edge of the rigid blade; and a convex surface, a straight surface or both adjacent a trailing edge of the rigid blade. In some implementations, the rigid blade includes a compliant tip on the rigid blade.

The rigid blade can include an ink channel to supply ink to the band. In some implementations, the ink feed device is integrated with the rigid blade to add the hot melt ink to the band via the ink channel. Moreover, in various implementations, the printing apparatus includes: a speed sensor associated with the band and configured to monitor a speed of the band; and a thickness sensor associated with the band and configured to monitor a thickness of the hot melt ink on the band after the blade; wherein the controller is communicatively coupled with the speed sensor, the thickness sensor, and the rigid blade, and the controller is configured to reposition the blade, in accordance with a viscosity of the hot melt ink and the speed of the band, to control the thickness of the hot melt ink on the band after the blade.

The controller can be configured to reposition the rigid blade by translating the rigid blade to adjust a pressure of the rigid blade against the band. The controller can be configured to reposition the rigid blade by rotating the rigid blade to adjust an angle of the rigid blade. In some implementations, the printing apparatus includes a roller or platen positioned on a non-ink side of the band, opposite the rigid blade, wherein the roller or platen includes a compliant layer that flexes when the rigid blade is pressed onto the band on an ink side of the band. In some implementations, the blade includes a pressure chamber opening at a leading edge of the rigid blade where a meniscus of melted hot melt ink forms on the band, and the meniscus sensor includes a pressure sensor associated with the pressure chamber. Further, in some implementations, the rigid blade includes an air channel to supply positive air pressure to the pressure chamber.

One or more aspects of the subject matter described in this specification can be embodied in one or more methods that include: transporting a band holding hot melt ink thereon in proximity to both a heating device and a thermal transfer printhead, where the thermal transfer printhead is adjacent a substrate; actuating heaters in the thermal transfer printhead to transfer a portion of the ink from the band to the substrate to create a print on the substrate; and operating an ink feed device and a blade, in accordance with the systems and techniques described herein, to control a thickness of the hot melt ink on the band. Other embodiments of this aspect include corresponding systems, apparatus, and computer program products.

Particular embodiments of the subject matter described in this specification can be implemented to realize one or more of the following advantages. Controlling the positioning of a blade used to re-ink a continuous band thermal transfer printer based on the viscosity of the hot melt ink used and the speed of the band can provide precise control over the thickness of ink on the band, thus enabling high quality thermal transfer printing at high speeds. Rather than having a coating process that is tuned to work at a single fixed speed, the systems and techniques described enable ink coating to work at variable speeds. Moreover, the systems and techniques described can take advantage of the shear-thinning properties of the ink whereby the viscosity of the ink drops as the speed of the coating increases, and one or more of the described mechanisms can produce a thin coating thickness (e.g., 5-25 μm) at a low cost.

Ink thickness and band speed sensors can be used to ensure the desired ink thickness is controlled accurately. Meniscus monitoring can be employed to provide precise control over the amount of ink that is added to the band, and various blade structures can be used to improve the accuracy of the meniscus monitoring. Moreover, control of a re-inking station based on a combination of inputs from an ink thickness sensor and a meniscus sensor can provide a robust and reliable thermal transfer printer.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIGS. 1A & 1B show examples of thermal transfer printers.

FIGS. 2A-2D show examples of rigid blades, which can be used in the thermal transfer printers of FIGS. 1B & 3A.

FIG. 3A shows another example of a thermal transfer printer.

FIGS. 3B and 3C show another example of a rigid blade, which can be used in the thermal transfer printer of FIG. 3A.

FIG. 3D shows an additional example of a rigid blade, which can be used in the thermal transfer printer of FIG. 3A.

FIG. 4 shows an example of an ink monitoring control subsystem, which can be used in the thermal transfer printers of the present application.

Like reference numbers and designations in the various drawings indicate like elements.

### DETAILED DESCRIPTION

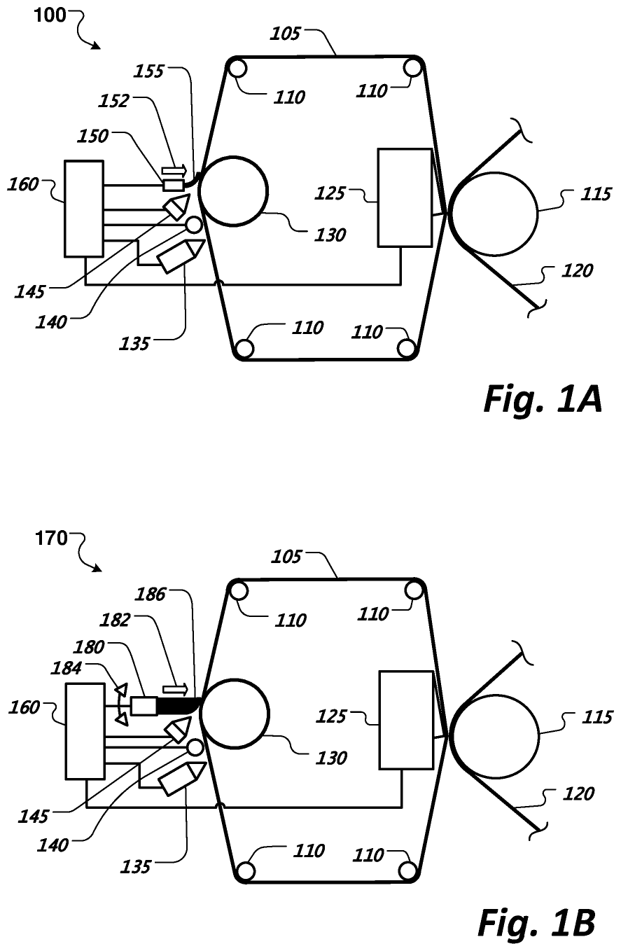

FIG. 1A shows an example of a thermal transfer printer 100. The thermal transfer printer 100 includes a band 105 entrained around rollers 110. The band can be made of various materials, such as polyimide film, engineering plastic, or metal. Selection of an appropriate thickness for a given type of band material can result in good heat transfer characteristics through the band 105, allowing high quality prints at high speed, while also maintaining the durability of the band 105. A print roller 115 can be used to transport a substrate 120 (e.g., paper or plastic) proximate to the band 105. A thermal transfer printhead 125 is adjacent to the substrate 120 and is used to transfer hot melt ink from the band 105 to the substrate 120. In some implementations, the printer 100 can be reconfigured to position the substrate 120 adjacent the printhead 125 on a platen, rather than a roller 115.

In some implementations, an additional roller 130 contacts a back side (i.e., non-ink side) of the band 105 and holds the band 105 in position relative to a re-inking station. Alternatively, a platen (e.g., a fixed flat platform) can be used in place of the roller 130, and the band 105 can slide over the surface that holds it in position relative to the re-inking station, rather than having the contacting surface move with the band 105 (as with a roller). In any case, the features described below with respect to the roller 130 can be implemented with a platen instead, in various implementations. In some implementations, the roller 130 has a fixed position. In other implementations, the roller 130 is moveable, such as in response to a control signal during printing or for purposes of installing or replacing the band 105 in the printer 100. The roller 130 presents a hard surface to the back side of the band 105. For example, the roller 130 can be made of metal and be generally unyielding when pressure is applied. In other implementations, the roller 130 is compliant (e.g., includes a compliant exterior layer) as described in further detail below.

The thermal transfer printer 100 includes an ink feed device 135 to add additional hot melt ink to the band 105 (as needed) and a blade support 150, which holds a flexible coating blade 155. The flexible coating blade 155 can be made of flexible engineering plastic (polymer) or spring steel and is pressed against the roller 130. The blade 155 can be held parallel to the band 105 and orthogonal to the direction of travel of the band. During printing operations, the blade 155 is bent against the roller 130, trapping the band 105 against the roller 130.

In some implementations, the roller 130 is heated in order to ensure the hot melt ink on the band 105 is in a molten state as it approaches the blade 155. For example, when a heated roller 130 is used as the only heating source, then the band 105 should be in contact with the surface of the roller 130 for sufficient time to allow any ink already on the band to melt before it reaches the blade 155. For a typical band 105 using engineering plastic and a coating speed of 400 mm/s the band 105 should be in contact with the surface for at least 20 mm before the blade 155. Additionally or alternatively, a heater 140 can be included to heat the ink so that it is fully melted before it reaches the blade 155. The heater 140 can be an infrared lamp or other radiant heater. In general, one or more heating devices are included. For example, in addition to using a heated roller 130, a heater 140, or both, the ink feed device 135 can be a heated ink feed device. In any case, at least one heating device should be close enough to the blade 155 to ensure that the hot melt ink is maintained in a molten state at the location of the blade 155. Moreover, the specific sequence of components leading up to the blade 155 can be changed, e.g., a heated ink feed device 135 can be placed after the heater 140 in the direction of travel of the band 105, rather than before (as shown).

One or more controllers 160 are also provided, each or all of which can be included in the thermal transfer printer 100 or be separate from the printer 100 but still included in a larger printing apparatus or system. In some implementations, a controller 160 operates the various components of the printer 100, including the printhead 125, the heated ink feed device 135, the heater 140, the blade support 150, and potentially a heated roller 130. The controller 160 can be implemented using special purpose logic circuitry or appropriately programmed processor electronics. For example, the controller 160 can include a hardware processor and software to control the printer 100, including controlling the speed of the band 105 to match the speed of the substrate 120, and the delivery of data to the printhead 125. The data can be delivered digitally, and the data can be changed with each print while the band 105 and substrate 120 continue to move at the same speed (e.g., 400 mm/s).

The position of the blade support 150, relative to the roller 130, allows the physical properties of the blade material to set the pressure exerted by the flexible blade 155 to control the ink thickness on the band 105. In other words, the thickness and mechanical properties of the blade 155 together with the support angle and position control the ink thickness. The control variables need to be changed when the physical properties of the ink (viscosity, etc.) alter. Thus, a controller 160 provides control signals to the blade support 150 to reposition the blade 155, in accordance with a viscosity of the hot melt ink and the speed of the band 105, to control the thickness of the hot melt ink on the band 105 after the blade 155.

For example, a pressure of the blade 155 can be controlled (e.g., by translation 152, such as by using a spring, a pneumatic cylinder, a micrometer, or a lead screw, which can be adjusted by a stepper motor) to achieve a balance due to the combination of the band speed, the ink viscosity, and the pressure, resulting in a controlled ink thickness. In general, increased viscosity leads to an increase in viscous forces, which leads to greater platen displacement, in accordance with the Navier-Stokes equation. In light of this, in some implementations, the control variables will adjust for more blade pressure with more viscous inks and lower band speeds in order to attain the same ink thickness. The general guidelines are that a small edge radius and narrow knife tip reduces pressure maximally.

Thus, the band 105 can be operated at variable speeds while also being coated with ink to the correct thickness. By taking advantage of the shear-thinning properties of the ink, whereby the viscosity of the ink drops as the speed of the coating increases, the thermal transfer printer 100 can produce a thin coating thickness (e.g., 5-25 μm) at a low cost. In addition, in some implementations, the controller 160 provides control signals to adjust a position of the blade 155 to compensate for wear of the blade material, which alters the mechanical properties of the blade 155 over the course of time. This adjustment mechanism is described in further detail below in connection with FIG. 4.

The controller 160 can include (or be coupled with) one or more sensors to assist in carrying out its functions. For example, a speed sensor can be associated with the band 105 to monitor the speed of the band 105. Alternatively, the speed of the band can be known by the controller 160, without the use of a sensor, as when the controller 160 itself controls the speed of the band 105. In addition, a thickness sensor can be associated with the band 105 to monitor a thickness of the hot melt ink on the band 105 after the blade 155. Moreover, in some implementations, an angle of the blade 155 can also be controlled to achieve the correct balance of forces to get the correct ink thickness in view of the ink viscosity and band speed. Note that the controller 160 can be divided into various subcomponents, which can operate in cooperation with each other or separately control the components of the printer 100, and further details regarding control subsystems are described below in connection with FIG. 4.

In addition, the one or more sensors can include a meniscus sensor 145, which monitors a size of a meniscus of melted ink that builds up in front of a leading edge of the blade 155. The meniscus sensor 145 can be an optical or ultrasonic sensor. When the data provided by the meniscus sensor 145 indicates a low meniscus level, the controller 160 causes ink to be added to the band 105 by the ink feed device 135. For further details regarding meniscus monitoring, see UK application GB1517636.5, filed Oct. 6, 2015, and entitled, “Tape Coating Apparatus and Printing Apparatus”, and also the corresponding PCT/EP2016/073847 application, filed on Oct. 6, 2015, and entitled, “Tape Coating Apparatus and Printing Apparatus”, and published as WO/2017/060333A1 on Apr. 13, 2017, both of which are hereby incorporated by reference.

FIG. 1B shows an example of a thermal transfer printer 170. Most of the components in the printer 170 are the same as those described above for the printer 100. However, the flexible blade 155 is replaced by a rigid (e.g., metal) blade 186 that is pressed against the band 105. In various implementations, the rigid blade 186 is made of metal, such as aluminum, stainless steel, titanium, or a combination of these. In addition, in some implementations, the rigid metal blade 186 is coated with an additional material to prevent or reduce wear and abrasion. For example, in some implementations, the rigid metal blade 186 is coated with an amorphous fluoroplastic, such as one or more types of TEFLON® PTFE (Polytetrafluoroethylene) coating materials, available from E. I. Du Pont de Nemours and Company (also known as DuPont) of Wilmington Del.

In addition, the roller 130 (or platen, as noted above) in the printer 170 is covered by a compliant layer, which provides some elasticity as the blade 186 is pressed against the band 105, thus facilitating control of the thickness of the ink on the band 105. In some implementations, the compliant material is of high Shore A durometer, which assists in controlling the film thickness. Generally, the lower the Shore A durometer, the thicker the coating film thickness onto the band 105. To keep a 2 to 5 μm coating thickness, a higher durometer (70 durometer Shore A or higher) is desirable. In some implementations, Hyperelastic polymers are used. Examples of materials that can be used include Silicone, Viton or EPDM or KALREZ. Viton is a brand of synthetic rubber and fluoropolymer elastomer commonly used in o-rings. EPDM rubber (ethylene propylene diene monomer (M-class) rubber) is a type of synthetic rubber, which is an elastomer characterized by a wide range of applications. KALREZ® by DuPont is a perfluoroelastomer. The elastomer can be combined with chemicals or fillers to improve heat conduction, reduce friction, reduce compression set and control hardness, etc. In some instances, the elastomer on the compliant layer can be covered by a low friction material such as PTFE film to reduce the friction forces on the band material as it moves through the coating apparatus.

In other implementations, other materials can be used for the compliant layer. In some implementations, the compliant layer has a lower limit of 75 Shore Duro A hardness. Below this limit, the rubber may be too soft to create a thin coating, depending on the ink used. However, depending on the viscosity change, softer rubbers should also perform well. In general, the compliant layer should be matched to the ink. In still other implementations, no compliant layer is used, and a gap between the rigid blade 186 and the roller 130 (or platen) is finely adjusted to control the thickness of the ink on the band 105.

The controller 160 for the printer 170 provides control signals to a blade support 180 to reposition the blade 186, in accordance with a viscosity of the hot melt ink and the speed of the band 105, to control the thickness of the hot melt ink on the band 105 after the blade 186. For example, a pressure of the blade 186 can be controlled (e.g., by translation 182, such as by using a spring, a pneumatic cylinder, a micrometer, or a lead screw, which can be adjusted by a stepper motor), and an angle of the blade 186 can be adjusted by rotation 184 (e.g., a lead screw driven by a stepper motor, with the lead screw being attached to the opposite side of the blade to the coating end, and where the blade is pivoted at a point governed by the tip design) to achieve a balance due to the combination of the band speed, the ink viscosity, the pressure, the blade angle, and any compliant coating on the roller 130, resulting in a controlled ink thickness. Further details regarding control subsystems that can be used to control the pressure and the blade angle are described below in connection with FIG. 4. Moreover, in some implementations, rather than using an ink feed device that is separate from a rigid blade, the ink feed device 135 and the rigid blade 186 (and potentially the heater 140) can all be combined into a single component, such as a slot die, as described in UK application GB1517636.5.

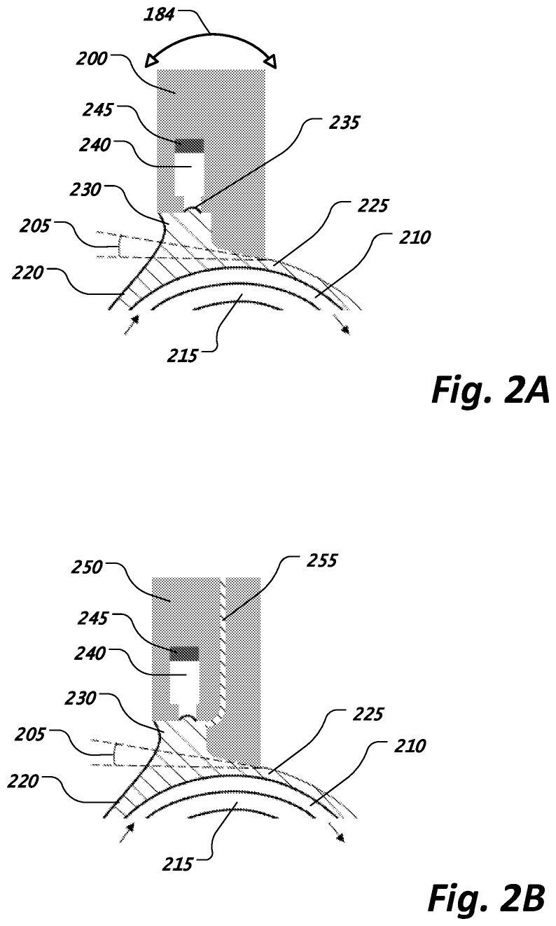

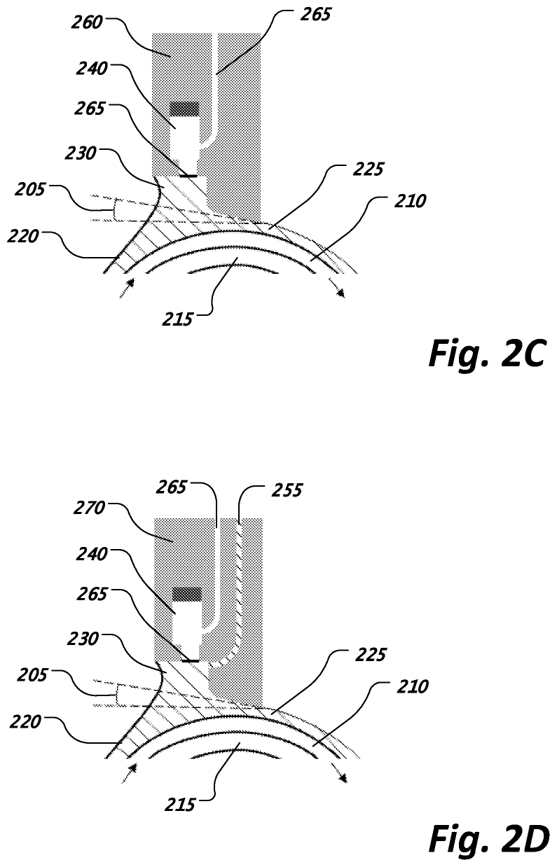

FIG. 2A shows an example of a rigid blade 200, which can be used in the thermal transfer printers described herein. The blade 200 is positioned with respect to a band 210 and a roller 215 (or platen) having a compliant material thereon, such as described above. The positioning of the blade 200 by a controller can set a blade angle 205 based on current parameters for the thermal transfer printer, including ink viscosity and the speed of the band 210 on the roller 215. As the band 210 moves, returning ink 220 approaches a leading edge of the blade, as shown. Since the returning ink 220 is melted, it forms an ink meniscus 230 in front of this leading edge of the blade. As noted above, by monitoring the size of this ink meniscus 230, a precise amount of ink to be added to the band 210 can be determined.

In addition, the blade positioning, including adjusting the blade angle 205 can be carefully controlled to ensure that the leveled ink 225 has the desired thickness. For example, at a coating speed of 100 mm/s using high viscosity ink (2-70 Pa·s) a blade angle of 28 degrees can be used, where blade angle is measured between the tangent to the roller 215 and the lower edge of the blade 200 (as shown). In addition, as the speed of the band 210 changes, the angle of the blade 200 can also be changed by rotation to ensure the leveled ink 225 remains at the correct thickness. Thus, the controller monitors the band speed so it can adjust the blade angle, as described herein. Moreover, in some implementations, the controller can monitor the quality of the coating 225 leaving the ink station and automatically adjust the blade angle 205 to control the coating quality.

Note that the dimensions of the features shown in FIG. 2A are not accurately to scale with respect to each other. Some features have been expanded for clarity. In some implementations, the band 210 thickness is 5 μm to 25 μm, or 5 μm to 20 μm, and the leveled ink 225 is on the order of 5 μm. In addition, the compliant layer thickness of the roller 215 (or platen) is dependent on the compliant material selected and the characteristics of the chosen ink.

Further, in some implementations, the blade 200 includes a pressure chamber 240 with a pressure sensor 245 in communication with the chamber. As the returning ink 220 builds up in front of the leading edge of the blade 200, it covers the aperture of the pressure chamber 240 and some of the ink 235 is pushed into the pressure chamber through this aperture/hole, thus increasing the air pressure inside the chamber 240. The pressure sensor 245 detects this change in pressure and can thus be used as a meniscus monitor. In some implementations, the pressure sensor 245 is used as the sole meniscus monitor. In other implementations, the pressure sensor 245 serves as an extra meniscus monitor, which can be used to double check or fine tune the data provided by the main meniscus monitor. In either case, the controller uses the pressure sensor 245 to monitor air pressure in the pressure chamber 240 to determine the ink position.

In some implementations, the size of the hole leading into the pressure chamber 240 is determined by the viscosity of the ink to be used with the thermal transfer printer. In some implementations, the blade 200, the roller 215, or both are heated. Moreover, additional variations are possible, as described herein.

FIG. 2B shows an example of a rigid blade 250, which can be used in the thermal transfer printers described herein. The blade 250 includes an ink channel 255 to supply ink to the band 210. Note that this is an example where the ink feed device 135 from FIG. 1B is integrated with a blade to add the hot melt ink to the band.

FIG. 2C shows an example of a rigid blade 260, which can be used in the thermal transfer printers described herein. The blade 260 includes an air channel 265 to supply positive air pressure to the pressure chamber 240, such as a low pressure air flow obtained from ambient air around the thermal transfer printer. This introduction of a flow of air into the pressure chamber 240 increases the pressure observed in the pressure chamber 240 when the hole is covered by ink, and thus prevents ingress of ink 265 into the pressure chamber 240, which can assist in keeping the pressure chamber 240 clean and ready to function properly.

During coating, the meniscus 230 volume is depleted. When the meniscus volume decreases to the point that the hole is exposed to atmosphere the pressure drops in the pressure chamber 240. The pressure drop is recognized by the controller and ink is added to the meniscus until the hole is again covered by ink and the pressure builds again in the pressure chamber signaling that the meniscus is replenished. Note that the precise size of the aperture can be adjusted at the time of manufacturing the thermal transfer printer in view of the expected application and ink(s) to be used. Moreover, in some implementations, the controller can vary the air flow amount to account for different viscosities of different types of inks to be used with the thermal transfer printer. Finally, FIG. 2D shows an example of a rigid blade 270, which can be used in the thermal transfer printers described herein, and which includes both an ink supply channel 255 and an air channel 265.

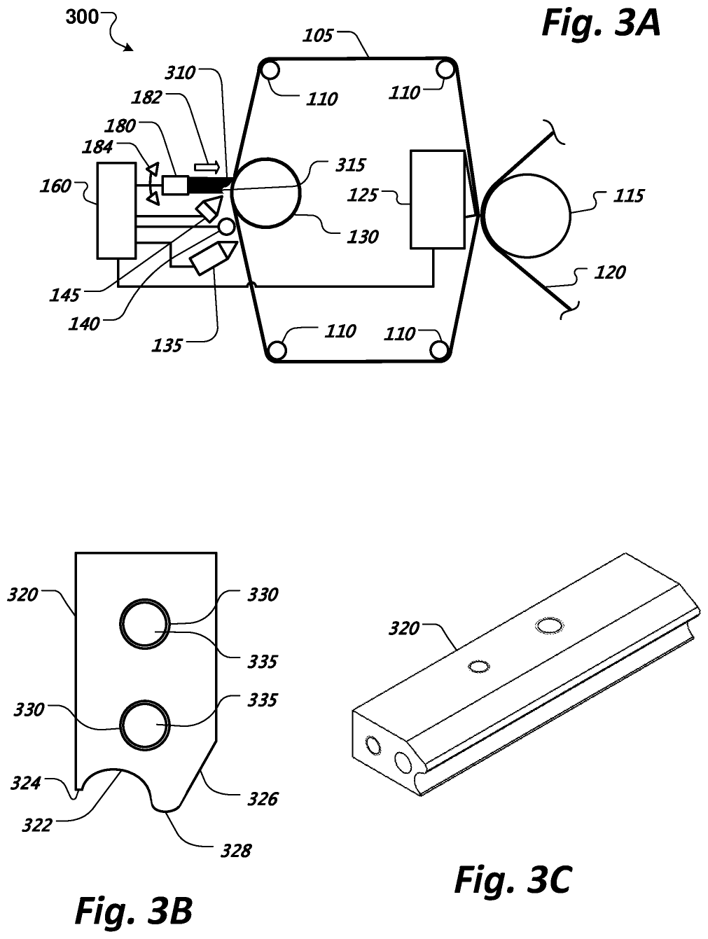

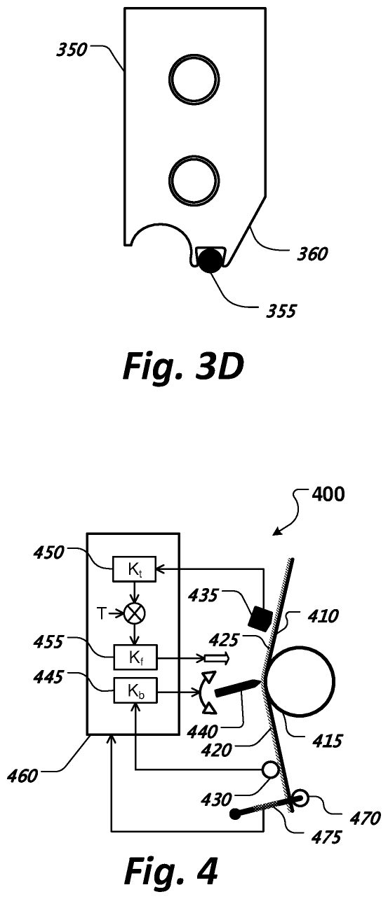

FIG. 3A shows an example of a thermal transfer printer 300. Most of the components in the printer 300 are the same as those described above for the printer 170. However, the rigid blade 186 is replaced by a rigid blade 310, which includes a concave surface 315 above the leading edge of the blade 310. As before, the blade can be a rigid metal blade held at a fixed position relative to the roller 130 or a fixed flat platform. The materials of the blade 310 can include those described above. Further, the gap between the blade 310 and the roller 130 (or platen) is adjustable to provide the desired ink coating thickness.

The blade 310 position can be set by a mechanical mechanism in the blade support 180, such as a micrometer or a lead screw. A stepper motor (or similar structure) can be used to adjust the lead screw and hence the position of the blade 310. In such implementations, the stepper motor is controlled by the controller 160. Moreover, as before, the blade angle can be adjusted by rotation 184 to control coating thickness. Thus the controller 160 can control the blade 310 position and angle relative to the roller 130 based on information regarding the band 105 speed and the characteristics of the ink(s) used. In some implementations, the controller 160 also receives an input from a sensor monitoring the coating thickness, as described further below in connection with FIG. 4. Thus, the controller 160 can implement a closed loop control system controlling the ink thickness based on the sensor signal.

Shaping the leading edge of the blade 310 to include a concave surface 315 provides control over the shape of the meniscus that forms in front of the blade 310 and prevents the ink from flowing up the blade 310. FIG. 3B shows a cross-sectional view of a detailed example of a rigid blade 320, which can be used in the thermal transfer printer of FIG. 3A. The leading edge of the blade 320 includes a concave surface 322 just after a jutting lip 324. The trailing edge of the blade 320 includes a straight surface 326, and the blade 320 includes a convex surface 328 between the straight surface 326 and the concave surface 322. In addition, the example blade 320 includes holes 330 to receive heating elements 335.

In some implementations, the angle of the straight surface 326 (with respect to vertical) is 25-35 degrees (e.g., 30 degrees), and the angle of a line connecting the jutting lip 324 with the tip of the concave surface 322 (with respect to horizontal) is 8-10 degrees (e.g., 9 degrees). FIG. 3C shows a perspective view of the blade 320. In many implementations, the blade 320 will be wider than the printhead of the thermal transfer printer, and the width of the band will also be wider than the printhead and may be wider than the blade 320. In various implementations, the printhead is from 32 mm to 128 mm (e.g., 53 mm). Note that the meniscus spreads across the whole of the blade 320, and thus the ink delivery system is designed to feed ink across the whole width of the blade 320, maintaining an even meniscus.

In addition, FIG. 3D shows another implementation in which a blade 350 is similar to the blade 320, but further includes a circular, compliant tip insert 355. This insert 355 is fit into the tip of the blade 350 and can be made of an elastomer material, such as a hardness 70 durometer, Viton material. In some implementations, the compliant tip insert 355 is a rubber o-ring (e.g., an o-ring of hardness 70 durometer, Viton material, with a diameter of 3 mm) fit into the tip of the blade 350. Moreover, in some implementations a straight surface 360 need not be angled, as shown, but rather can be aligned vertically.

FIG. 4 shows a portion 400 of a thermal transfer printer, including an example of an ink monitoring control subsystem 460, which can be used in each of the thermal transfer printers of the present application. The thermal transfer printer includes a band 410, a roller 415, and returning hot melt ink 420 on the band 410. In addition, a blade 440 conditions the ink on the band 410 and can be repositioned by translation, rotation, or both.

A speed sensor 430 can be used to monitor the actual speed of the band 410. The speed sensor 430 can be a roller attached to a rotary encoder, or any other appropriate device to measure speed. Moreover, in some implementations, the control system controls the speed of the band 410 and thus already knows the speed of the band without using a speed sensor. Nonetheless, it can be beneficial to include a speed sensor 430 to confirm the speed information. In any case, the speed can be monitored by the control system, which can apply a transfer function (K_{b}) 445 to the speed signal to determine the angle of the blade. In some implementations, the transfer function K_{b} is a linear function, e.g., the change in angle is directly proportional to the change in speed. In other implementations, the transfer function K_{b} is a non-linear function. The exact form of the function can be determined by the temperature and resulting viscosity of the ink on the band 410. In some implementations, the transfer function uses the shear and temperature dependent viscosity to extract the optimal blade angle based on the pressure generated by the coating speed.

For various implementations, to determine precise values to use for ink viscosity, coating speed, blade angle, and/or applied pressure, various computational modelling programs can be used, such as Computational Fluid Dynamics (CFD) software and/or Finite Element Analysis (FEA) software. For example, for a given ink, CFD software and FEA software can be used to generate a rheological characterization of the ink that shows the shear thinning of the ink and simulation results of the pressure change the ink undergoes when being applied to the band. Various methods can be used to measure the material's response to changing temperature, time and stress/strain, such as (1) a strain sweep method (the ink's response to increasing oscillating shear stress is measured at various predefined temperatures while holding frequency constant), (2) a thermal sweep method (the frequency and strain are held constant while the temperature is ramped between two values, e.g., from 70° C. to 140° C. at a rate of 5° C./minute), (3) a frequency sweep method (the time dependence of the ink's flow properties are measured while the strain and the temperature are held constant), and/or (4) a flow method (the dependence of viscosity on shear rate is measured at various predefined temperatures over a shear rate range, e.g., a shear rate range of 0.1 sec⁻¹ to 1000 sec⁻¹). Using such methods and known computer simulation programs, the ink(s) to be used can be analyzed to determine rheological characterizations corresponding to ink properties, such as ink viscosity shear and temperature dependence, which then informs the design of the thermal transfer printer system, as described herein.

In addition, an ink thickness sensor 435 observes the leveled ink 425 on the band 410 and provides a data signal to indicate whether the desire thickness is being achieved. The ink thickness sensor 435 can be a laser or ultrasonic sensing device, or any other appropriate device that can achieve the necessary resolution, e.g., a resolution that is at least ten times higher than the desired ink thickness. The desired ink thickness (T) can be received as an input, or be predefined for a given thermal transfer printer, and is used to control the lateral pressure applied to the blade 440. The ink monitoring control subsystem 460 implements a closed loop control algorithm using the thickness value feedback from the ink thickness sensor 435, fed through a filter 450 implementing a transfer function (Kₜ) and a filter 455 implementing a forward transfer function (K_{f}). The exact value of the transfer functions Kₜ and K_{f} is determine by the mechanical layout of the final printer system and can be adjusted using standard control techniques, which are well understood in the field. The control algorithm can be implemented using electronic circuits or more typically a software algorithm within a control system microcontroller.

In addition, in some implementations, the controller 460 provides control signals to adjust a position of the blade 440 to compensate for wear of the blade material, which alters the mechanical properties of the blade 440 over the course of time. This mechanism can detect such wear by detecting the coating thickness using the ink thickness sensor 435. If the coating thickness increases (all other control inputs being constant) then the blade can be presumed to be worn, and therefore the blade position can be adjusted accordingly. Note that wear of the continuous band 410 will have a similar effect on the coating, so the same control response can be used to compensate for wear of the band 410. Moreover, in some implementations, a roller 470 (around which the band 410 is entrained) is attached to a spring arm 475 that is used to keep the band 410 at the correct tension, and the spring arm 475 can be monitored by the control subsystem 460 (or another control subsystem of the thermal transfer printer) to identify wearing of the band 410 based on detection of the band 410 stretching over time, as indicated by a change in position and/or tension in the spring arm 470.

Embodiments of the subject matter and the functional operations described in this specification can be implemented using digital electronic circuitry, computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium (e.g., a machine-readable storage device, a machine-readable storage substrate, a memory device, or a combination of one or more of them) for execution by, or to control the operation of, data processing apparatus. The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in appropriate cases be excised from the combination, and the claimed combination may be directed to a subcombination or variation of a subcombination.

Thus, particular embodiments of the invention have been described. Other embodiments are within the scope of the following claims. Moreover, the actions recited in the claims can be performed in a different order and still achieve desirable results.

1. A printing apparatus comprising:
a band capable of holding hot melt ink thereon;
rollers arranged to hold and transport the band with respect to a substrate;
a printhead configured to thermally transfer a portion of hot melt ink from the band to the substrate to print on the substrate;
an ink feed device configured to add hot melt ink to the band, a heating device configured to heat the hot melt ink on the band, and a rigid blade proximately located with the heating device and configured to control ink thickness of the hot melt ink on the band, wherein the rigid blade includes a pressure chamber opening at a leading edge of the rigid blade where a meniscus of melted hot melt ink forms on the band;
a pressure sensor associated with the pressure chamber configured to monitor the meniscus of the melted hot melt ink on the band; and
a controller communicatively coupled with the pressure sensor and the ink feed device, wherein the controller is configured to cause the ink feed device to add hot melt ink to the band based on data from the pressure sensor regarding the meniscus of the melted hot melt ink on the band.

2. The printing apparatus of claim 1, wherein the rigid blade includes an air channel to supply positive air pressure to the pressure chamber.

3. The printing apparatus of claim 2, wherein the rigid blade includes an ink channel to supply ink to the band, and the ink feed device is integrated with the rigid blade to add the hot melt ink to the band via the ink channel.

4. The printing apparatus of claim 3, comprising a thickness sensor associated with the band and configured to monitor a thickness of the hot melt ink on the band after the blade, wherein the controller is communicatively coupled with the thickness sensor and the rigid blade, and the controller is configured to reposition the blade, in accordance with a viscosity of the hot melt ink and a speed of the band, to control the thickness of the hot melt ink on the band after the blade.

5. The printing apparatus of claim 4, wherein the controller is configured to reposition the rigid blade by rotating the rigid blade to adjust an angle of the rigid blade.

6. The printing apparatus of claim 4, wherein the controller is configured to reposition the rigid blade by translating the rigid blade to adjust a pressure of the rigid blade against the band.

7. The printing apparatus of claim 4, comprising a roller or platen positioned on a non-ink side of the band, opposite the rigid blade, wherein the roller or platen includes a compliant layer that flexes when the rigid blade is pressed onto the band on an ink side of the band.

8. The printing apparatus of claim 4, wherein the heating device comprises a roller or platen positioned on a non-ink side of the band, opposite the rigid blade.

9. A method comprising:
transporting a band holding hot melt ink thereon in proximity to both a heating device and a thermal transfer printhead, where the thermal transfer printhead is adjacent a substrate;
actuating heaters in the thermal transfer printhead to transfer a portion of the ink from the band to the substrate to create a print on the substrate; and
operating an ink feed device and a blade to control a thickness of the hot melt ink on the band, wherein the operating comprises causing the ink feed device to add hot melt ink to the band based on data from a pressure sensor regarding a meniscus of the melted hot melt ink on the band, the pressure sensor being associated with a pressure chamber opening at a leading edge of the blade.
